(19) United States
(12) Patent Application Publication
(10) Pub. No.: US 2005/0172051 A1
(43) Pub. Date: Aug. 4, 2005

(54) Method of data transmission

(76) Inventors: Chi-Tung Chang, Taipei County (TW); Hung-Chou Tsai, Nantou County (TW)

Correspondence Address: Chi-Tung Chang, 7F., No. 213, Civic Boulevard. Sec. 4, Taipei, 105, TW

(21) Appl. No.: 10/769,611

(22) Filed: Jan. 29, 2004

(51) Int. Cl. G06F 3/00

(52) U.S. Cl. 710/36

(57) ABSTRACT

A method of data transmission for transmitting data between a host and a consumptive electronic apparatus without USB interface via an interconnecting interface that has an end being a USB for connecting to the host. The method includes the steps of generating an instruction by the host; sending the instruction to the consumptive electronic apparatus without USB interface via the interconnecting interface; and verifying the instruction at the consumptive electronic apparatus without USB interface and then executing any movement requested by the instruction, and feeding back a signal of executing result to the host. Therefore, a consumptive electronic apparatus without USB interface may be connected to a host for data transmission at reduced cost.

### FIELD OF THE INVENTION

The present invention relates to a method of data transmission, and more particularly to a data transmission method in which a consumptive electronic apparatus without universal serial bus (USB) interface is indirectly connected to a host via an interconnecting interface having a USB, so that data may be transmitted between the host and the consumptive electronic apparatus to achieve the purpose of data sharing.

### BACKGROUND OF THE INVENTION

The Universal Serial Bus (USB) is one of the most noticeable products in the new generation of connecting interfaces at the end of year 1998, and has quickly become widely known in the market. The specification of USB has actually long been established mainly by Intel in 1996. However, most operating systems at that time did not well support USB products because of the high cost when they were first introduced into the market, preventing the USB products from being widely accepted by users. Thanks to the introduction of iMAC, which uses USB interface, into the market and the built-in support provided by Windows 98, USB products eventually become the hottest products in the computer field.

As compared with the conventional expansion ports or slots, USB largely simplifies the complicity in the connection to various kinds of expansion slots. It enables series connection of up to 127 devices to one computer (this is a theoretical value that may be reached depending on the cooperation between a USB hub and a signal cable, and current experiments indicate up to 111 USB devices may be series connected to one computer via the USB connector), and has the advantages of enabling hot attach and detach as well as plug-and-play. This means a user does not need to care the differences between various kinds of connecting ports or dismount the computer case or wait for normal shutdown to install/unplug a peripheral. The user only needs to connect a new peripheral to an externally accessible standard USB slot and execute the steps for installing a driver, and the new peripheral can immediately operate normally. Theoretically speaking, any device adapted to transmit digital data may be designed to have a USB interface. Thus, a lot of devices, including loudspeakers, keyboards, mice, scanners, printers, digital cameras, etc., may be designed to connect to a computer via a USB interface. That is why the USB interface becomes so hot and popular.

The USB is a standard connecting interface, which allows connection of an external apparatus to a computer without the need of re-allocating and re-planning the whole system, or the need of open the computer case to adjust the finger-tip controlled switch of the interface card. When a new peripheral is connected to a computer via the USB interface, the computer will automatically identify the new peripheral and actuate an appropriate driver. The user needs not to change the settings of the computer. A starting point on the USB interface for connecting a USB device is referred to as the “host”, which is a USB head for controller output. The USB head may be welded to a base plate or located at an external position. Currently, most base plates may support up to 4 USB plugs each. A regular high-speed USB cable must have aluminum foil and polyester shielding to prevent deterioration of signal during transmission via the cable. The cable internally includes four wires, two of which are positive and negative electrodes for electric power, and the other two are positive (D+) and negative (D−) electrodes for signal. It is important for the four wires to evenly fix to a cable core. An advantage of using a 4-wire cable is to reduce and simplify the plug connections, and to enable easy control of hardware manufacturing cost of the product.

The following are some of the features and advantages of the USB:
1. The USB interface unifies the connectors for various kinds of peripherals. All the communication interface, printer interface, display output, sound input/output device, and storage device use the same USB interface specification. The USB interface functions like a universal contact. A user needs only to insert a plug to complete all things.
2. The USB has the feature of plug-and-play and is able to automatically detect and allocate system resources. Moreover, the USB interface does not require system resources. That is, it is not necessary for a USB device to additionally set for other system resources, such as interrupt request (IRQ), I/O address, and direct memory access (DMA).
3. The USB has the feature of Hot Attach & Detach. That is, a USB device may be plugged to or unplugged from the computer while the operating system is in a started and operating state. It is not necessary for the user to shut down the computer before connecting a USB device thereto.
4. The USB interface version 1.1 has a transmission speed of 12 Mbps that satisfies most user demands. Of course, a high-speed USB interface 2.0 provides even better transmission rate.
5. One USB interface allows connection of up to 127 peripherals to it. Since the USB interface uses a 7-bit addressing field, it provides total 2⁷=128 usable addresses. After deduction of the one address that is preset by the USB host for a peripheral first connected to the computer, there are still 127 addresses available for use. Therefore, up to 127 USB devices may be connected to a computer via the USB interface.

In brief, an overall function of the USB is to simplify the connection between the external peripherals and the mainframe of a computer. With the USB, only one single transmission cable is used for series connection of various kinds of peripherals, such as the parallel port for a printer and the serial port for a modem, and the confusing problem of having a large mass of tangled cables and wires behind the mainframe is solved.

However, aside from the electronic products that are provided with a USB interface, there are still many other consumptive electronic apparatuses that might need to connect to a host via a USB connector on the host for data transmission. In this case, the consumptive electronic apparatuses must have a USB connecting slot provided thereon to enable data transmission between it and the host. Therefore, some of the consumptive electronic apparatuses, such as calculators, palm-top electronic games, electronic organs, etc., that could not include a USB interface due to cost or limited functions of processor thereof are not able to download new versions of software or externally connect to a host to edit data stored in such electronic apparatuses. Without the ability of data sharing, these consumptive electronic apparatuses seem to be incomplete for use.

It is therefore tried by the inventor to develop a economical method of data transmission that enables data transmission between a consumptive electronic apparatus without USB and a host via an interconnecting interface.

### SUMMARY OF THE INVENTION

A primary object of the present invention is to provide a method of data transmission that enables data transmission between a consumptive electronic apparatus without USB and a host via an interconnecting interface, and accordingly achieves the function of data sharing.

To achieve the above and other objects, the method of data transmission according to the present invention is implemented by connecting a consumptive electronic apparatus without USB interface to a host via an interconnecting interface that has an end being a USB for connecting to the host. The method includes the steps of generating an instruction by the host; sending the instruction to the consumptive electronic apparatus without USB interface via the interconnecting interface; and verifying the instruction at the consumptive electronic apparatus without USB interface and then executing any movement requested by the instruction, and feeding back a signal of executing result to the host. Therefore, a consumptive electronic apparatus without USB interface may be connected to a host for data transmission at reduced cost.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram showing the connection between different components for implementing the method of the present invention; and

FIG. 2 is a flowchart showing detailed steps included in the data transmission according to the method of the present invention.

### DETAILED DESCRIPTION OF THE PREFERRED EMBODIMENTS

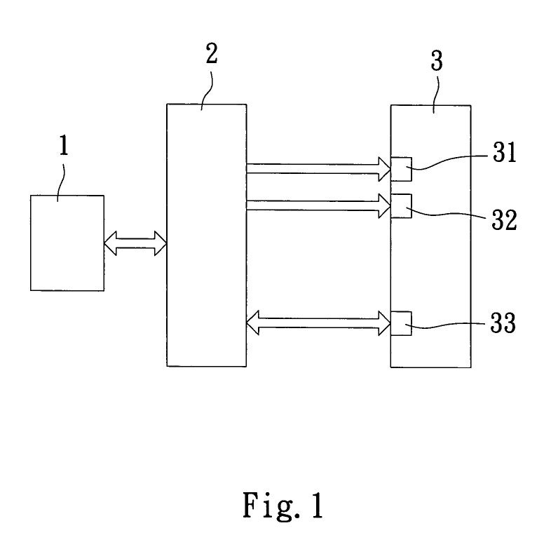

Please refer to FIG. 1 that is a block diagram showing the connection of different components for implementing the method of data transmission of the present invention.

As shown, to implement the method of the present invention, a consumptive electronic apparatus without USB interface 3 is connected to an interconnecting interface 2, which has an end adapted to connect to the electronic apparatus 3, and another end being a USB adapted to connect to a host 1, so that data can be transmitted between the host 1 and the electronic apparatus 3 via the interconnecting interface 2.

The method of data transmission according to the present invention includes the following steps: (a) generating an instruction by the host; (b) sending the instruction generated by the host 1 to the consumptive electronic apparatus without USB interface 3 via the interconnecting interface 2; (c) verifying the instruction at the consumptive electronic apparatus without USB interface 3 and executing any movement requested by the instruction; and (d) sending a result from executing the instruction to the host 1.

The consumptive electronic apparatus without USB interface 3 includes at least a connecting module 31 adapted to connect to the interconnecting interface 2, an instruction receiving unit 32 adapted to receive the instruction sent from the host 1 via the interconnecting interface 2, and a data processing unit 33 adapted to execute the instruction received by the instruction receiving unit 32 and generate a signal indicating the result from executing the instruction.

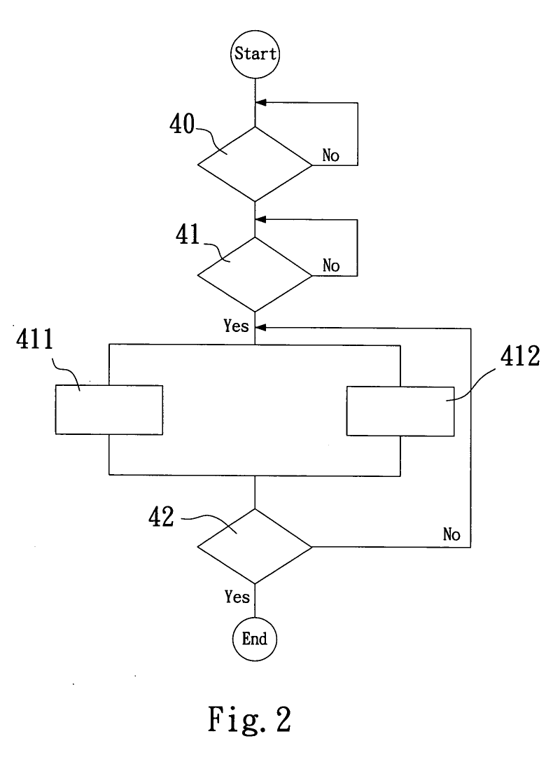

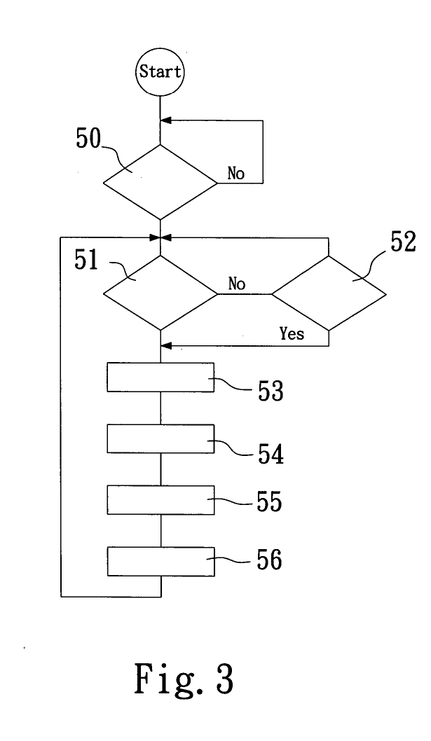

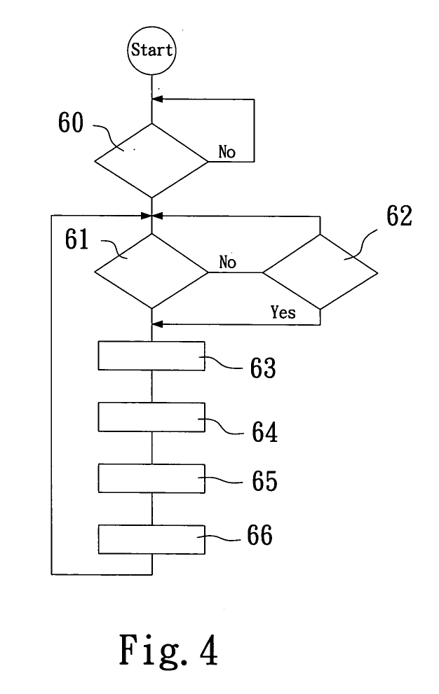

Please refer to FIG. 2 that is a flowchart showing detailed steps included in the data transmission according to the method of the present invention.

When it is desired to connect the consumptive electronic apparatus without USB interface 3 to the host 1 for data transmission, the host 1, the interconnecting interface 2, and the consumptive electronic apparatus without USB interface 3 are detected to find out whether they are duly connected to one another to enter a state allowing data transmission therebetween (Step 40). If the components are not in the state for data transmission between them, the connecting state is detected once again. When the components are in the state for data transmission, it is further determined whether there is an instruction from the host 1 indicating any movement to be executed (Step 41). If there is not any instruction input from the host 1 to the consumptive electronic apparatus 3, the latter enters into a standby state. When there is an instruction from the host 1, the instruction is sent to the consumptive electronic apparatus without USB interface 3 via the interconnecting interface 2. When the instruction is a download instruction, a download procedure is executed (Step 411); or when the instruction is an upload instruction, an upload procedure is executed (Step 412). When the download or the upload procedure is completed, it is checked whether the desired data has been transmitted (step 42), and a signal indicating an executing result is generated by the electronic apparatus 3 and fed back to the host 1. Or, in the event the data transmission is determined as failed in the Step 42, the download or the upload procedure in Step 411 or 412 is repeated again.

The instruction generated by the host 1 for executing a required movement may be a Reset, a Retry, a download, or an upload instruction. And, the signal indicating the executing result may be a Completed, Error (Retrial Allowed), or Failed (Reset Required).

In this manner, a consumptive electronic apparatus without USB interface may be indirectly connected to a host for data transmitted and achieve the purpose of data sharing without the need of having a USB interface built in the consumptive electronic apparatus.

1. A method of data transmission for transmitting data between a host and a consumptive electronic apparatus without USB interface via an interconnecting interface that has an end being a USB for connecting to said host and another end for connecting to said consumptive electronic apparatus; said method comprising the steps of:
generating an instruction by said host;
sending said instruction to said consumptive electronic apparatus without USB interface via said interconnecting interface;
verifying said instruction at said consumptive electronic apparatus without USB interface and then executing any movement requested by said instruction; and
feeding back a signal of executing result to said host.

2. The method of data transmission as claimed in claim 1, wherein said instruction may be a Reset, Retry, Download, or Upload instruction.

3. The method of data transmission as claimed in claim 1, wherein said consumptive electronic apparatus without USB interface includes:
a connecting module adapted to connect to said interconnecting interface;
an instruction receiving unit adapted to receiving said instruction sent from said host via said interconnecting interface; and
a data processing unit adapted to execute said instruction received by said instruction receiving unit, and generate a signal indicating an executing result.

4. The method of data transmission as claimed in claim 3, wherein said signal indicating the executing result may be a Completed, Error (Retrial Allowed), or Failed (Reset Required) signal.
